(19) United States
(12) Patent Application Publication
(10) Pub. No.: US 2007/0177968 A1
(43) Pub. Date: Aug. 2, 2007

(54) Device for moving objects contained inside an automatic vending machine

(76) Inventors: Giuseppe Riello, Verona (IT); Luigi Zecchetto, Minerbe (IT); Giorgio Calciolari, Legnago (IT)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 10/562,631

(22) PCT Filed: Jun. 26, 2003
(86) PCT No.: PCT/IT03/00395

§ 371 Date: Mar. 23, 2007

(51) Int. Cl. B65G 1/133

(52) U.S. Cl. 414/749.6

(57) ABSTRACT

A device for the manipulation and movement of objects contained inside a magazine which is equipped with a plurality of housings, each designed to accommodate an object to be transferred. The device is mobile on a plane (X,Y) in front of the magazine and positionable in front of each of the housings, and comprises a cell to contain an object. The device comprises a carriage, which moves in a direction (Z) at right angles to the plane (X,Y) on respective guides in the lower part of the cell, and also comprises a slide mechanically connected to the carriage and moving in the same direction as the carriage; the upper surface of the carriage and of the slide form a support surface for an object to be transferred. The device also comprises a mechanism for activating the carriage and the slide by means of an appropriate source of motion.

### TECHNICAL FIELD

The present invention refers to a device for the manipulation and movement of objects contained inside an automatic dispensing machine.

More in particular, this invention refers to a manipulating device that makes it possible to pick up an object present in a predetermined position inside an automatic dispensing machine, and to move this object in such a way as to make it available to a user outside the dispensing machine.

The invention can be mainly applied in the sector of the manufacture of automatic dispensing machines.

### BACKGROUND ART

Various types of automatic dispensing machines are known to the background art, covering a wide variety of applications, activated by the insertion of tokens, notes, credit or debit cards, magnetic or electronic cards, etc.

These automatic dispensing machines, which can be installed indoors or outdoors, generally consist of a casing, normally in metal, containing a fixed or mobile magazine with a plurality of housings, inside each of which a certain object is positioned.

Payment of a certain amount (by coins, tokens, notes, electronic or magnetic cards, etc.) gives the user the possibility of access to one of these housings, or to the object it contains.

A wide variety of objects can be contained in these automatic dispensing machines, for example cigarettes, flowers, food and drink, video cassettes, audio or video disks, medical or paramedical items, etc.

By way of example, European patent application no. EP-A-577121 describes an automatic device for the distribution of audiovisual and digital recorded items.

This device comprises a fixed magazine, consisting of a plurality of adjacent housings arranged in respective rows or columns, each housing-being designed to contain one of the said items, at least one manipulating unit to pick up and discharge the items externally through a slot, a device for reading an identification label associated with each item, a device through which the user can select a certain item, and automatic payment means which allow withdrawal of the item.

The housings have different shapes and sizes according to the respective shapes of the items they are designed to accommodate.

The manipulation unit comprises a pair of parallel carriages which move along vertical guides and a cursor which moves along a second horizontal guide connected to these carriages; a blocking element is rigidly associated with this cursor for the manipulation of the items.

This blocking element comprises mobile gripper jaws and a device for automatically varying the distance between the gripper jaws along another guide.

The entire device is extremely complicated as regards construction since it requires the presence of numerous motors, the movements of which must be coordinated and synchronized with great precision.

Furthermore, due to the bulky structure of the machine, which has one or more fixed magazines, the delivery times of the items are quite long which can be annoying to the user of the machine.

Another automatic dispensing machine for video cassettes and/or DVDs, known to the background art, generally comprises a magazine enclosed in a casing and an interface unit easily accessible from the outside.

With reference to FIG. 1, the magazine 30 usually consists of a series of housings arranged vertically one above the other, each being defined by a pair of profiles 31, 31′ which protrude from a support upright (not shown in the figure), at predetermined intervals vertically.

Pairs of adjacent profiles 31-31′, 32-32′ etc. form housings designed to accommodate cases for recorded objects of different types, in particular video cassettes 33 and/or DVDs 34.

The distance between two consecutive profiles is such as to form a housing to accommodate DVD cases, which are supported by two coplanar ledges projecting towards each other from two respective consecutive profiles belonging to the same row, or video cassettes which are also supported by a pair of ledges on the profiles.

As can be seen in FIG. 1, each ledge is integral with the respective profile 31, 31′ . . . with a central connecting bar that gives the ledge-bar pair a “double T” cross-section.

The video cassette 33 and/or DVD 34 recorded objects enclosed in their respective cases are normally moved from and to the respective housings by means of an appropriate movement device known to the background art.

The device (not shown in the figures) usually consists of a carriage, connected to an upright positioned at the side of the magazine, and is moved and controlled automatically within a vertical plane identified by two axes conventionally called X, Y.

In particular, the movement along the axis Y takes place along the aforesaid upright, while the movement along the axis X takes place in front of the respective magazine housings.

The carriage also comprises a pair of arms which extend at right angles, therefore along the axis conventionally called Z, to the movement plane of the carriage.

These arms generally move within the free space between two vertically adjacent profiles.

The arms comprise conveyor belts with a relatively irregular surface, which are able to move a case in the direction identified by the axis Z.

When one wishes to withdraw a case from a predetermined position inside the magazine, the carriage is first moved along the respective axes Y and X with the aim of positioning the arms of the carriage immediately below the case in question. The arms are then raised in such a way as to slightly raise the case and thus place it in contact with the conveyor belts, which are activated in order to move the case. The case moves along the axis Z into a special housing in the carriage. The carriage moves back along the axes Y and X until it reaches a case discharge station where, in a similar way, the case is transferred from the carriage to a discharge device.

The same procedure is carried out, in reverse order, to insert a case in a respective housing.

The movement device described above presents a series of drawbacks and disadvantages which limit its possibility of use.

One drawback is represented by the fact that the withdrawal and the insertion of the video cassette or DVD by means of belts requires relatively extensive maneuvering spaces for the carriage, reducing maneuverability and rapidity of the movements.

Another drawback is represented by the fact that since the profiles need gaps and slots for the passage of the carriage arms, they constitute a relatively deformable structure since the ledges and the bars, designed to support the product, protrude from the upright, undergoing flexural effects that compromise the positioning precision of the housing for the product.

A further drawback is represented by the fact that the belts work by friction, thus being subject to wear and tear and unable to guarantee sufficient reliability in carrying out their job.

Yet another drawback that cannot be ignored consists of the fact that the upright on which the carriage is positioned is housed in a space at the side of the magazine, increasing the overall dimensions of the dispensing machine.

Solutions have already been proposed which use gripping means in place of the belts, for example the use of side grippers working with a non-continuous gripping technique known as “pilgrim process”.

While these solutions resolve some of the typical problems mentioned above, they are not without drawbacks due to the slow speed of the working operations and to the difficulty of gripping objects with a limited thickness such as, for example, DVD cases.

### DESCRIPTION OF THE INVENTION

The present invention proposes to provide a device for manipulating and moving objects contained inside an automatic dispensing machine and which can eliminate or significantly reduce the drawbacks described above.

This invention also proposes to provide a movement device which is safe, reliable and long-lasting.

The last but not least aim of this invention is to provide a device for manipulating and moving objects contained inside an automatic dispensing machine and which can be produced with accuracy and precision so as to be qualitatively advantageous.

This is achieved by means of a device for manipulating and moving objects contained inside an automatic dispensing machine with the features described in the main claim.

The dependent claims described advantageous forms of embodiment of the invention.

According to the invention, the device for manipulating and moving objects contained inside a magazine equipped with a plurality of housings, each designed to accommodate an object to be transferred, moves along a plane (X,Y) in front of the magazine and can be positioned in front of each of the housings. According to the invention, the device comprises a cell (11) to accommodate an object and a carriage, moving in a direction (Z) at right angles to the plane (X,Y) on respective guides in the lower part, of the cell.

The device also comprises a slide mechanically connected to the carriage and moving in the same direction as the carriage; typically, the upper surface of the carriage and of the slide form a support surface for the object to be transferred. The device also comprises a mechanism to activate the carriage and the slide through an appropriate source of motion.

According to an advantageous embodiment of the invention, the slide has a longitudinal slot, substantially parallel to its direction of movement, designed to house a respective bar comprising elastic loading means designed to allow minimal movements of the bar.

At each longitudinal end, the bar is equipped with a stop tooth, in operation projecting at right angles from the slide support surface, designed to restrain the product during withdrawal and insertion.

The reduced movements of the bar with respect to the slide, limited by the elastic loading means, allow adaptation of the stop teeth to the dimensions of the product in order to compensate for slight positioning inaccuracies inside the magazine housings.

The elastic loading means consist of leaf springs which can be fixed to the central part of the slide and striking against the respective pins on the bar.

Advantageously there is a single source of motion, consisting of an electric motor.

According to the invention, the kinematic connection between the carriage and the source of motion for the movement on the respective guides consists of a gear-rack pair.

Advantageously, the slide comprises a rack designed to engage with end gear wheels of a step-up gear train receiving motion from a primary drive gear cooperating with the source of motion.

The step-up gear train guarantees a high translation speed of the slide in working conditions both during the forward and return movements of the carriage.

The translation of the moving parts, carried out by gears, guarantees high positioning precision and excellent reliability with respect to movement made by conveyor belts or toothed belts.

The cell can move inside the magazine, simultaneously combining motions in two directions, reaching a predetermined position more quickly thanks to the fact that the withdrawal and insertion of products takes place in front of the magazine that houses them.

### DESCRIPTION OF THE DRAWINGS

Other features and advantages of the invention will become evident on reading the following description of some form of embodiment of the invention, given as non-binding examples, with the help of the enclosed drawings, in which:

FIG. 1 is a schematic perspective view of part of a magazine designed to house various types of recorded objects;

FIG. 2 represents a schematic view from above of a carriage equipped with a manipulating and movement device according to the present invention; and

FIG. 3 shows an enlarged plan view, with details in cross-section, of a gear train of the carriage in the previous figures.

### DESCRIPTION OF A FORM OF EMBODIMENT

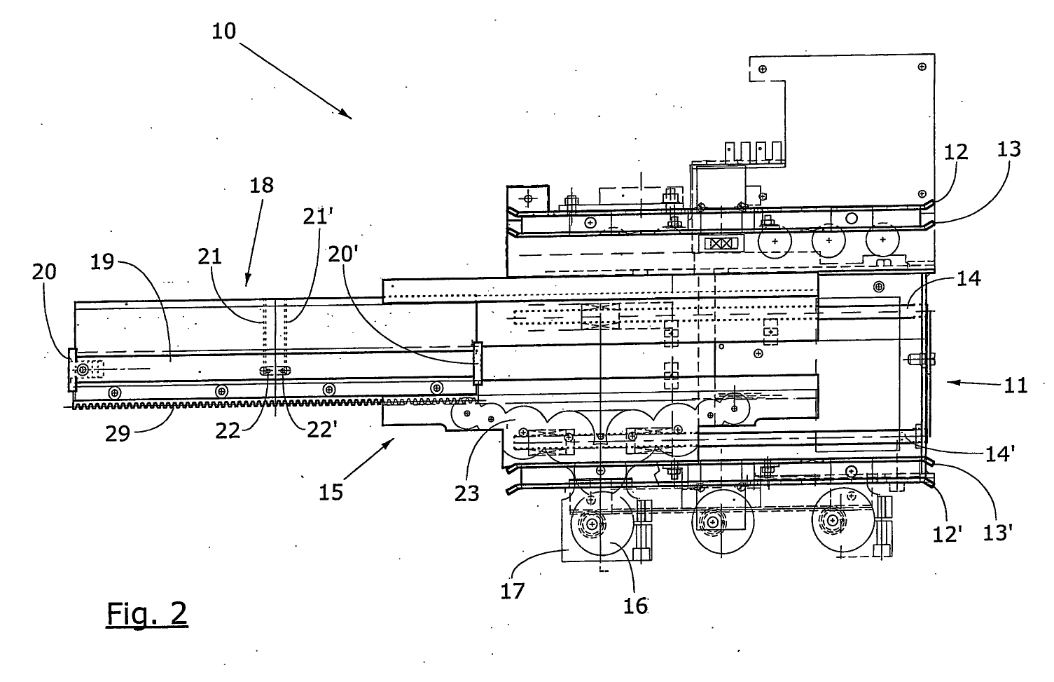

In FIG. 2, the reference number 10 generally indicates a device for manipulating and moving objects contained inside an automatic dispensing machine, comprising a magazine for the storage of these objects.

The embodiment described below consists of an automatic dispenser of video cassettes or DVDs, of the type normally used in rental outlets. It is nevertheless clear that the invention is not limited to the use of the manipulating and movement device for dispensers of this type, and the device in question can easily be used for the movement of objects of any kind such as, for example, flowers, tobacconist or photography items, medical and paramedical articles, etc.

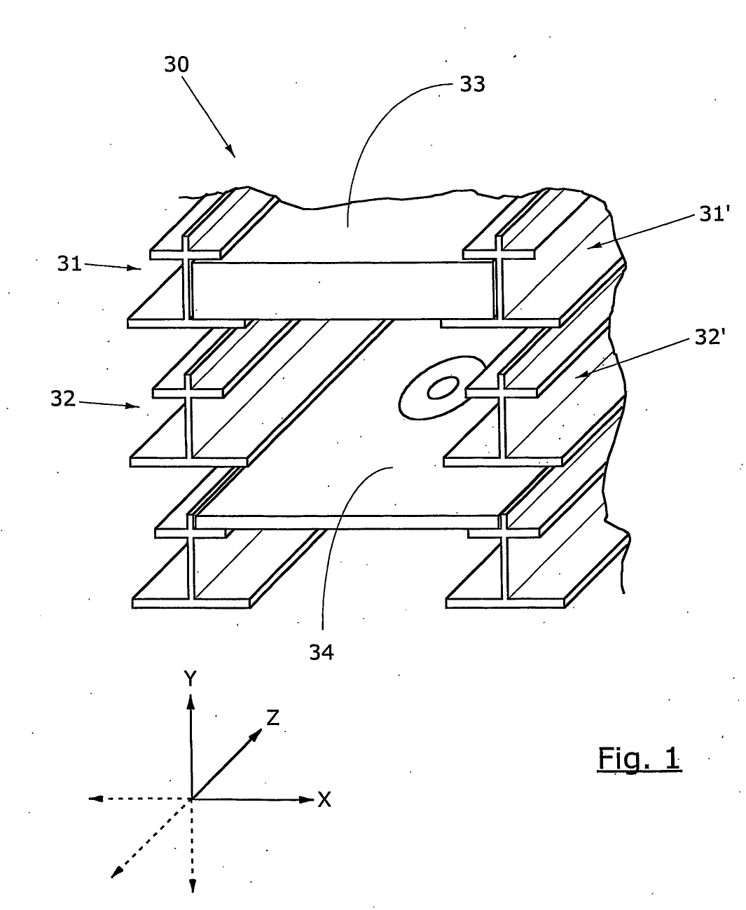

The movement device 10 comprises a cell 11 which moves, through appropriate kinematic motion, on a vertical plane (X,Y) positioned in front of a magazine 30 (see FIG. 1) comprising a plurality of housings, each designed to accommodate an object 33, 3-4 to be transferred from the housing to a discharge device or vice versa.

In general, the movement of the device 10 along the plane is controlled by an appropriate electronic unit, equipped with means for memorising the position of each magazine housing. In the case in question, which refers to an automatic dispenser of recorded objects, the electronic control unit can be equipped with a plurality of electronic circuits and sensors for the identification of particular recorded objects and their transfer. This control electronics is known to the background art and is not part of the present invention.

The cell 11 of the movement device 10 is bordered at the sides by pairs of guides 12-12′ or 13-13′. In the case in question, the cell 11 is designed to house a product, for example a video cassette or a DVD, during the transfer phase from a housing to the discharge device and vice versa.

The lower part of the cell 11 is equipped with a pair of guides 14-14′, in the case in question consisting of two parallel cylindrical bars, for the sliding of a carriage 15 which has a pair of holes for housing these guides 14-14′.

The carriage 15 is integral with a side casing 17 designed to house a source of motion, for example an electric motor 16.

Furthermore, the body of the carriage 15 presents a central longitudinal cavity and two side guides, designed to house a slide 18 which, together with the upper surface of the carriage 15, provides a support surface for the product to be transferred.

According to a particularly advantageous embodiment of the invention, the slide 18 has a longitudinal slit, extending along its entire length and designed to house a bar 19 equipped, at each longitudinal end, with a respective striker element 20-20′ protruding beyond the support surface of the slide 18.

Advantageously, the bar 19 comprises elastic loading means 21-21′, designed to return it to the central rest position from any limited longitudinal travels with respect to the slide 18, in order to adapt the positioning of the striker elements 20-20′ with respect to the edges of the product to be picked up.

The presence of these elastic loading means 21-21′ also makes it possible to directly compensate for any irregularities in the vertical layout of the magazine and its housings for the products to be transferred.

These elastic loading means can consist of leaf springs 21-21′ which can be fixed to the central part of the slide 18 and strike against the respective pins 22-22′ of the bar 19.

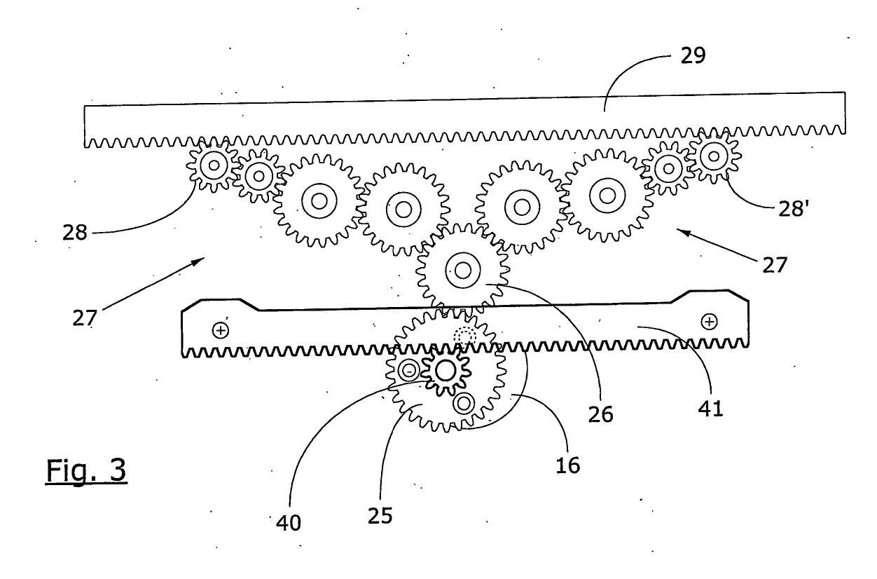

The side of the carriage 15, adjacent to the casing 17, is equipped with a protective guard 23 for a step-up gear train 24 (see FIG. 3).

The step-up gear train 24 comprises a primary driving wheel 25, integral with the shaft of the electric motor, engaging with a central gear wheel 26 which transmits the motion to two lateral trains of spur gears 27-27′, each ending with a small driven gear wheel 28-28′.

Each driven gear wheel 28-28′ engages with a rack 29 integral with one side of the slide 18 which can thus move out of and into the carriage 15 according to the rotation direction transmitted by the motor shaft to the primary gear 25.

A second driving gear 40 is fixed to the motor shaft, above the gear wheel 25, and designed to engage with a rack 41 integral with the cell.

The rotation of this second driving gear 29 allows the carriage 15 to move with respect to the cell 11 simultaneous with the movement of the slide 18.

As can be seen in FIG. 2, the slide 18 can be rapidly moved to the working position protruding from the carriage 15 which in turn moves in the same direction with respect to the cell 11.

In this way it is possible to position the cell 11 in front of the product housing in the magazine; the subsequent positioning of the slide 18 below any product container, for example a video cassette or a DVD, allows the withdrawal or insertion of the product thanks to grip guaranteed by the striker elements 20-20′ of the bar 19.

Considering FIG. 2, the carriage 15 can obviously be moved to the right or the left with respect to the central cell 11, which moves on the plane (X,Y).

In this context, it can be noted that during the movement of the device 10 on the plane (X,Y), the carriage 15 and the slide 18 are in the central position and are thus contained within the overall dimensions of the device 10.

On the other hand, when the device 10 is stationary in the transfer position, the carriage 15 and the slide 18 move away from or towards the magazine housing or the discharge device, respectively, in order to withdraw or insert a product.

Thanks to this layout, it is possible to reduce the overall dimensions of the outer casing inside which the device according to the invention is mounted. It is also possible to use magazines with box-type housings, more reliable from a structural and dimensional point of view with respect to those illustrated in FIG. 1, which consist of profiles with a protruding structure to allow the insertion of the traditional arms foreseen in devices know to the background art.

The invention is described above with reference to a preferred form of embodiment.

It is nevertheless clear that the invention is susceptible to variations which are within the framework of technical equivalents.

1. A device for the manipulation and movement of objects contained inside a magazine equipped with a plurality of housings, each designed to accommodate an object to be transferred, the device being mobile on a plane (X,Y) in front of the magazine and positionable in front of each of the housings, the device comprising a cell to contain an object, the device being characterised in that it comprises a carriage, which moves in a direction (Z) at right angles to the plane (X,Y) on respective in the lower part of the cell, also comprising a slide mechanically connected to the carriage hand mobile in the same direction as the carriage, in which the upper surface of the carriage and of the slide form a support surface for an object to be transferred, and in that the device also comprises a mechanism for activating the carriage and the slide by means of an appropriate source of motion.

2. The device of claim 1, wherein said carriage comprises a cavity bordered by a pair of side guides, the slide being positioned inside this cavity and being movable along the side guides.

3. The device of claims 1, wherein said slide presents a longitudinal slot inside which is a bar, each end of which is equipped with a striker element.

4. The device to of claim 3, wherein said works with elastic loading means designed to allow minimal longitudinal movements of the bar and to guarantee its centering.

5. The device of claim 4, wherein said elastic loading means consist of leaf springs which can be fixed to the central part of the slide and striking against respective pins on the bar.

6. The device of claim 1, wherein said single source of motion for the movement of the carriage and of the slide consisting of a electric motor.

7. The device of claim 6, wherein said electric motor is housed inside a casing integral with one side of the carriage.

8. The device of claim 1, wherein said carriage and the source of motion are kinematically connected by means of a first rack integral with the carriage and a driving gear fixed to the shaft of the electric motor.

9. The device of claim 1, wherein said slide and the source of motion are kinematically connected by means of a second rack designed to engage with at least one end driven gear wheel of a step-up gear train receiving the motion from a primary driving gear cooperating with the source of motion.

10. The device of claim 8, wherein said gear train is housed inside a protective guard positioned at the side of the carriage close to the casing.

11. The device of claim 1, wherein said objects to be transferred consist of recorded objects.

12. The device of claim 1, wherein said objects to be transferred consist of photographic products, medical or paramedical items, prepackaged food or drink items, flowers or tobacconist articles.

13. The device of claim 1, wherein said device is mounted inside an automatic dispensing machine.

14. The device of claim 13, wherein said automatic dispensing machine is designed to dispense recorded objects such as video cassettes and/or DVDs or other audiovisual items.
